(19) United States
(12) Patent Application Publication
(10) Pub. No.: US 2016/0121891 A1
(43) Pub. Date: May 5, 2016

(54) SYSTEM AND METHOD FOR CONTROLLNG ACCELERATION TORQUE OF VEHICLE

(71) Applicant: Hyundai Motor Company, Seoul (KR)

(72) Inventors: Sang Joon Kim, Seoul (KR); Dong Ho Yang, Geoje (KR); Jae Hoon Cho, Suwon (KR)

(21) Appl. No.: 14/840,643

(22) Filed: Aug. 31, 2015

(30) Foreign Application Priority Data
Oct. 30, 2014 (KR) 10-2014-0148946

(51) Int. Cl. B60W 30/16

(52) U.S. Cl. CPC B60W 30/16; B60W 2520/10; B60W 2540/10; B60W 2550/142; B60W 2550/302; B60W 2550/308

(57) ABSTRACT

A system for controlling acceleration torque of a vehicle includes: a driving information detection unit that detects driving information of the vehicle; a forward-vehicle detector that detects the information about another vehicle located substantially ahead of the vehicle; and a control unit that calculates a basic acceleration torque and a basic slew rate of the vehicle when the vehicle is accelerating based on the detected driving information, calculates a desired acceleration torque and a final slew rate by correcting the basic acceleration torque and the basic slew rate based on the detected information about the other vehicle, and outputs a torque-related order to adjust a torque output from a power system of the vehicle to the desired acceleration torque in accordance with the final slew rate.

### CROSS-REFERENCE TO RELATED APPLICATION

This application claims under 35 U.S.C. §119(a) the benefit of and priority to Korean Patent Application No. 10-2014-0148946 filed on Oct. 30, 2014, the entire contents of which are incorporated herein by reference.

### BACKGROUND

(a) Technical Field

The present disclosure relates generally to a system and a method for controlling acceleration torque of a vehicle. More particularly, it relates to a system and a method for controlling acceleration torque which can improve fuel efficiency by controlling acceleration torque based on information about a nearby vehicle.

(b) Background Art

Typically, when a driver rapidly operates the accelerator pedal of a vehicle, it has an adverse influence on fuel efficiency of the vehicle. In order to prevent such a problem, some vehicles utilize a driving mode called an “ECO Mode.”

In general, the ECO Mode achieves an effect of improving fuel efficiency by limiting an acceleration torque change rate when an acceleration pedal is operated, as compared with a normal mode. Referring to FIG. 1, in a normal mode, when a driver operates an accelerator pedal, acceleration torque (i.e., basic acceleration torque for a power system) according to driving information, such as the vehicle speed, the engaged gear, and the position of the accelerator pedal (i.e., signal value from APS), is determined as desired torque, and the torque output from the power system is increased to satisfy the desired torque. The power system generally refers to the engine of conventional vehicles, the engine and the motor of hybrid vehicles, or the motor of electric vehicles.

Desired torque is achieved from engine torque for acceleration in conventional vehicles (i.e., those with an engine), whereas desired torque is achieved only from motor torque in electric vehicles. As for hybrid vehicles, desired torque is achieved from a combination of engine torque and motor torque, and when acceleration torque is determined, it is designated to an engine and a motor in a predetermined ratio.

On the other hand, when the ECO Mode is selected, the desired torque is decreased and a slew rate is limited in comparison to a normal mode. However, the function of the ECO Mode addresses limiting the slew rate, so it may cause unnecessary torque even though the distance from a vehicle ahead is small, which is disadvantageous with respect to the fuel efficiency of a vehicle.

The above information disclosed in this Background section is only for enhancement of understanding of the background of the disclosure, and therefore, it may contain information that does not form the related art that is already known in this country to a person of ordinary skill in the art.

### SUMMARY OF THE DISCLOSURE

The present disclosure has been made in an effort to solve the above-described problems associated with prior art and to provide a system and a method for controlling acceleration torque which can improve fuel efficiency of a vehicle by controlling acceleration torque based on information about a nearby vehicle when a driver operates an accelerator pedal.

According to embodiments of the present disclosure, a system for controlling acceleration torque of a vehicle includes: a driving information detection unit that detects driving information of the vehicle; a forward-vehicle detector that detects information about another vehicle located substantially ahead of the vehicle; and a control unit that calculates a basic acceleration torque and a basic slew rate of the vehicle when the vehicle is accelerating based on the basis of the detected driving information, when a vehicle is accelerated, and that calculates a desired acceleration torque and a final slew rate by correcting the basic acceleration torque and the basic slew rate of the vehicle based on the detected information about the other vehicle, and outputs a torque-related order to adjust a torque output from a power system of the vehicle to the desired acceleration torque in accordance with the final slew rate.

The driving information detection unit may include: a vehicle speed detector that detects a vehicle speed of the vehicle; and an accelerator pedal position detection unit that detects an accelerator pedal position of the vehicle. The control unit may calculate the basic acceleration torque based on the vehicle speed and the accelerator pedal position using a torque map.

The system may further include: a slope detector disposed in the vehicle that detects a road slope. The control unit may correct the basic acceleration torque and the basic slew rate based on the detected information about the other vehicle and the detected road slope.

The information about the other vehicle may include one or more of an inter-vehicle distance between the vehicle and the other vehicle and a relative speed of the vehicle with respect to the other vehicle.

Furthermore, according to embodiments of the present disclosure, a method of controlling acceleration torque of a vehicle includes: detecting driving information of the vehicle; detecting information about another vehicle located substantially ahead of the vehicle; calculating a basic acceleration torque and a basic slew rate based on the detected driving information; calculating a desired acceleration torque and a final slew rate by correcting the basic acceleration torque and the basic slew rate based on the detected information about the other vehicle; and outputting a torque-related order to adjust a torque output from a power system of the vehicle to the desired acceleration torque in accordance with the final slew rate.

The detecting of the driving information of the vehicle may include: detecting a vehicle speed of the vehicle; and detecting an accelerator pedal position of the vehicle. The basic acceleration torque may be calculated based on the vehicle speed and the acceleration pedal position using a torque map.

The method may further include detecting a road slope. The basic acceleration torque and the basic slew rate may be corrected based on the detected information about the other vehicle and the detected road slope.

The method may further include: calculating the desired acceleration torque according to the detected road slope and a torque map; and calculating the final slew rate according to the detected road slope and a slew rate map.

The torque map may be set such that a larger road slope corresponds to a larger desired acceleration torque, and the slew rate map may be set such that a larger road slope corresponds to a larger final slew rate.

The method may further include calculating the desired acceleration torque according to a torque map.

The method may further include calculating the final slew rate according to a slew rate map.

The information about the other vehicle may include one or more of an inter-vehicle distance between the vehicle and the other vehicle and a relative speed of the vehicle with respect to the other vehicle.

The method may further include calculating the desired acceleration torque according to a torque map. The torque map may be set such that a larger road slope corresponds to a larger desired acceleration torque.

The method may further include calculating the final slew rate according to a slew rate map. The slew rate map may be set such that a larger road slope corresponds to a larger final slew rate.

Furthermore, according to embodiments of the present disclosure, a non-transitory computer readable medium containing program instructions for controlling acceleration torque of a vehicle includes: program instructions that calculate a basic acceleration torque and a basic slew rate based on detected driving information of the vehicle; program instructions that calculate a desired acceleration torque and a final slew rate by correcting the basic acceleration torque and the basic slew rate based on detected information about another vehicle located substantially ahead of the vehicle; and program instructions that output a torque-related order to adjust a torque output from a power system of the vehicle to the desired acceleration torque in accordance with the final slew rate.

Therefore, according to the system and method for controlling acceleration torque of the present disclosure, it is possible to increase fuel efficiency by controlling acceleration torque based on information about an inter-vehicle distance and a relative speed to a nearby vehicle (e.g., ahead of the driving vehicle), when a driver operates an accelerator pedal.

Other aspects and embodiments of the disclosure are discussed infra.

### BRIEF DESCRIPTION OF THE DRAWINGS

The above and other features of the present disclosure will now be described in detail with reference to certain embodiments thereof illustrated in the accompanying drawings which are given hereinbelow by way of illustration only, and thus are not limitative of the present disclosure, and wherein:

FIG. 1 is a diagram illustrating acceleration torque control according to the related art;

FIG. 2 is a block diagram illustrating the configuration of a system for controlling acceleration torque according to embodiments of the present disclosure;

FIG. 3 is a block diagram illustrating a configuration for calculating acceleration torque in a system for controlling acceleration torque according to embodiments of the present disclosure;

FIG. 4 is a flowchart illustrating a process of controlling acceleration torque according to embodiments of the present disclosure;

FIGS. 5A and 5B are diagrams illustrating desired acceleration torque to an inter-vehicle distance and a relative speed in a method of controlling acceleration torque according to embodiments of the present disclosure; and

FIGS. 6A and 6B are diagrams illustrating a slew rate to an inter-vehicle distance and a relative speed in a method of controlling acceleration torque according to embodiments of the present disclosure.

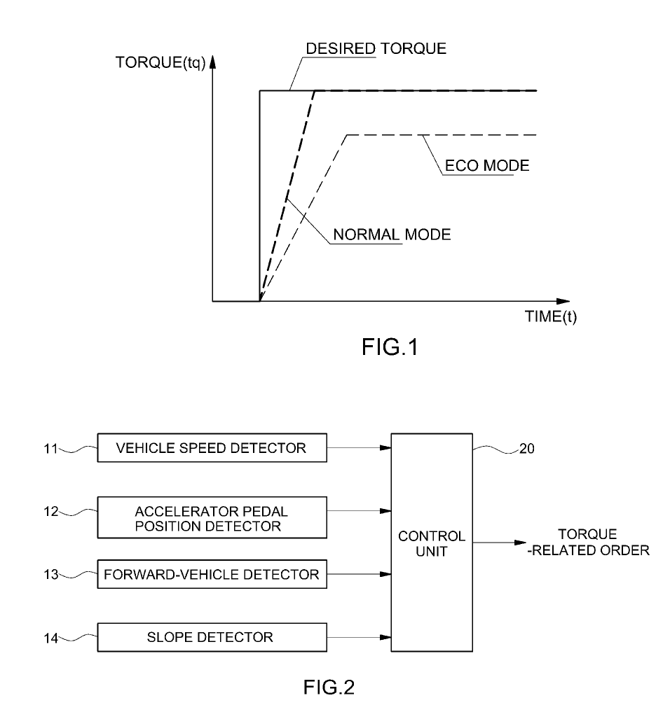

Reference numerals set forth in the Drawings includes reference to the following elements as further discussed below:

| | |
|---|---|
| 11: vehicle speed detector | 12: accelerator pedal position detector |
| 13: forward-vehicle detector | 14: slope detector |
| 20: control unit | |

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment. In the figures, reference numbers refer to the same or equivalent parts of the present disclosure throughout the several figures of the drawing.

### DETAILED DESCRIPTION OF THE EMBODIMENTS

Hereinafter reference will now be made in detail to various embodiments of the present disclosure, examples of which are illustrated in the accompanying drawings and described below. While the disclosure will be described in conjunction with embodiments, it will be understood that present description is not intended to limit the disclosure to those embodiments. On the contrary, the disclosure is intended to cover not only the embodiments, but also various alternatives, modifications, equivalents and other embodiments, which may be included within the spirit and scope of the disclosure as defined by the appended claims.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one control unit. The term “control unit” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the control unit in conjunction with one or more other components, as would be appreciated by a person of ordinary skill in the art.

Furthermore, the control unit of the present disclosure may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

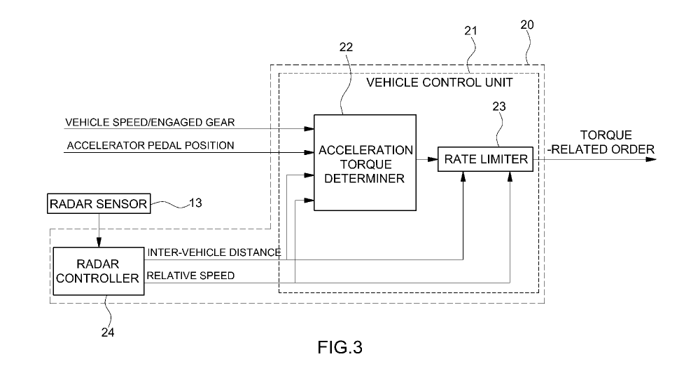

Referring now to the disclosed embodiments, FIG. 2 is a block diagram illustrating the configuration of a system for controlling acceleration torque according to embodiments of the present disclosure and FIG. 3 is a block diagram illustrating a configuration for calculating acceleration torque in a system for controlling acceleration torque according to embodiments of the present disclosure.

As shown in FIGS. 2 and 3, a system for controlling acceleration torque of a vehicle according to embodiments of the present disclosure includes a driving information detection unit that detects driving information, a running information detection unit that detects running information, and a control unit 20 that calculates desired acceleration torque and a slew rate on the basis of the driving information and the running information, when a vehicle is accelerated.

The driving information detection unit includes a vehicle speed detector 11 for detecting a vehicle speed and an accelerator pedal position sensor (APS) 12 for detecting an accelerator pedal position. The running information detection unit, which is provided to detect an inter-vehicle distance and a relative speed to another vehicle located substantially ahead of the vehicle in which the system for controlling acceleration torque is installed, may include a forward-vehicle detector 13 for detecting the information about the other vehicle ahead. The running information detection unit may further include a slope detector 14 for detecting the slope of a road, other than the forward-vehicle detector 13. The forward-vehicle detector 13 includes an inter-vehicle distance sensor and the inter-vehicle distance sensor may be a radar sensor that detects an inter-vehicle distance to the other vehicle ahead in real-time (e.g., as shown in FIG. 3). The slope detector 14 which is provided to detect a road slope (i.e., inclination) that is running resistance against a vehicle, may be a G-sensor in a vehicle for obtaining an inclination angle of a vehicle and a road slope, which may be used to determine a running resistance, is determined on the basis of a signal value from the G-sensor.

The control unit 20 acquires an inter-vehicle distance and a relative speed to a vehicle ahead, from detection data of the vehicle speed detector 11 and the forward-vehicle detector 13, and determines desired acceleration torque and a slew rate on the basis of the information about a vehicle speed and an engaged gear, an accelerator pedal position (e.g., signal value from APS), and the information about an inter-vehicle distance and a relative speed. The control unit 20 also calculates a torque-related order for increasing torque output from a power system up to desired acceleration torque in accordance with the slew rate. The control unit 20 may be a single integrated control unit and may be a common engine control unit for common vehicles with an engine, or a Vehicle Control Unit (VCU) or a Hybrid Control Unit (HCU) 21, which is the highest class control unit for hybrid vehicles and electric vehicles.

When the forward-vehicle detector 13 is a radar sensor, the control unit 20 may further include a radar controller 24 that calculates an inter-vehicle distance and a relative speed from detection data of the radar sensor, as illustrated in FIG. 3. When the radar controller 24 transmits an inter-vehicle distance and a relative speed to the vehicle control unit 21, the vehicle control unit 21 determines desired acceleration torque and a slew rate in consideration of the inter-vehicle distance and the relative speed. An acceleration torque determiner 22 of the vehicle controller 21 receives the information about a vehicle speed, an engaged gear, and an accelerator pedal position, determines basic acceleration torque on the basis of the information, and determines the final desired acceleration torque by correcting the basic acceleration torque in accordance with the inter-vehicle distance and the relative speed. A rate limiter 23 of the vehicle control unit 21 determines the final slew rate by correcting a basic slew rate in accordance with an inter-vehicle distance and a relative speed and outputs a torque-related order for desired acceleration torque and a slew rate.

A process of controlling acceleration torque according to embodiments of the present disclosure is described hereafter.

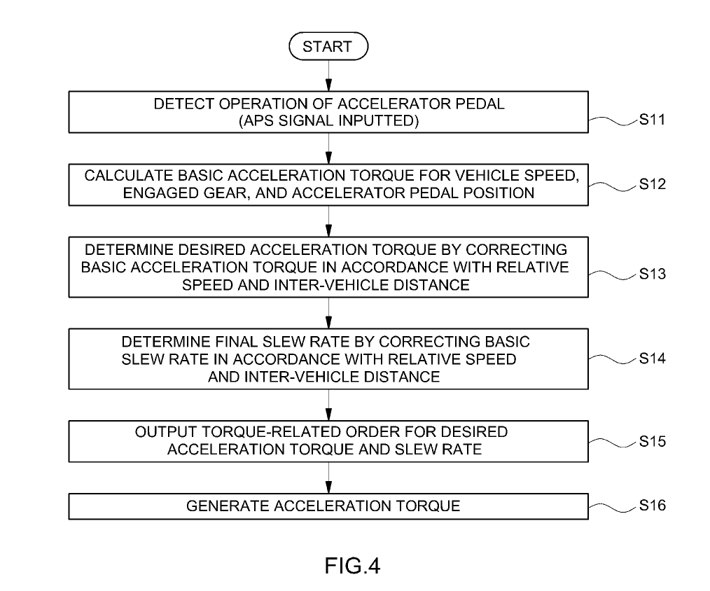

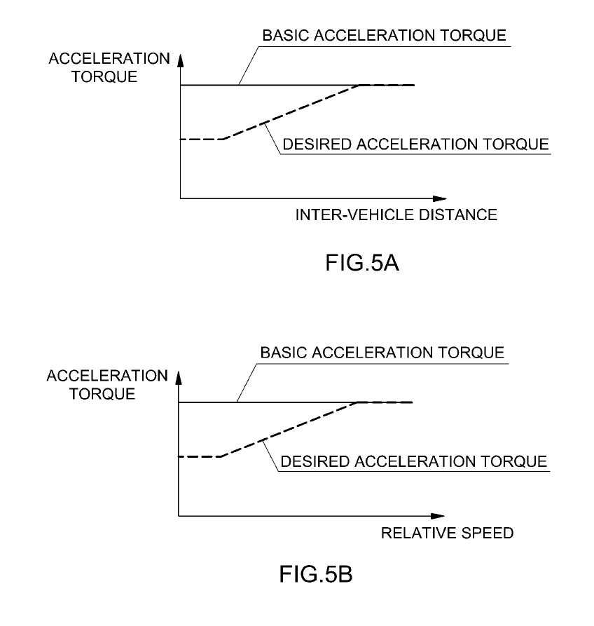

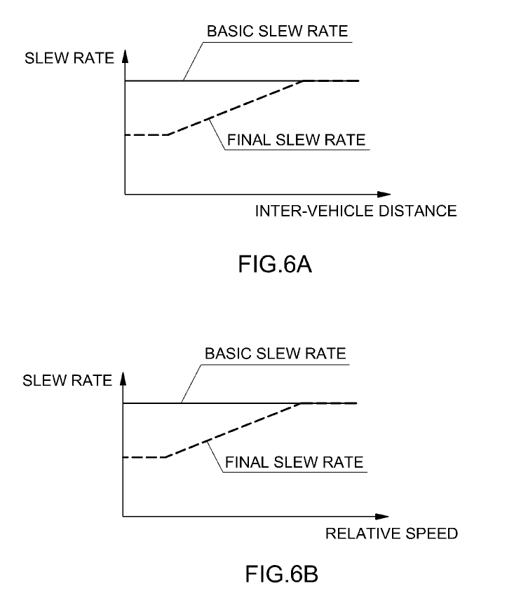

FIG. 4 is a flowchart illustrating a process of controlling acceleration torque according to embodiments of the present disclosure, FIGS. 5A and 5B are diagrams illustrating desired acceleration torque to an inter-vehicle distance and a relative speed in a method of controlling acceleration torque according to embodiments of the present disclosure, and FIGS. 6A and 6B are diagrams illustrating a slew rate to an inter-vehicle distance and a relative speed in a method of controlling acceleration torque according to embodiments of the present disclosure.

When a driver operates an accelerator pedal, the control unit 20 recognizes the operation of the accelerator pedal from a detection signal (i.e., APS signal) from the accelerator pedal position detection unit 12 (S11) and calculates basic acceleration torque from the information about the vehicle speed, the engaged gear, the accelerator pedal position which are detected by the vehicle speed detection unit 11. The basic acceleration torque is acceleration torque that is obtained on the basis of a vehicle speed and an accelerator pedal position with a D-gear engaged in the related art, and for example, when the minimum torque and the maximum torque for the current vehicle speed are obtained from a minimum torque line with the minimum torque (or creep torque) according to a vehicle speed and a maximum torque line with the maximum torque (i.e., available maximum output torque from a power system) according to a vehicle speed, the basic acceleration torque can be obtained by multiplying the sum of the minimum torque and the maximum torque by a value corresponding to an accelerator pedal position, based on an APS value, for example However, the basic acceleration torque may be calculated using any suitable method understood to a person of ordinary skill in the art.

When the basic acceleration torque is calculated, as described above, the control unit determines the final desired acceleration torque by correcting the basic acceleration torque on the basis of the inter-vehicle distance and the relative speed (S13). A torque map, which is set such that desired acceleration torque can be extracted on the basis of an inter-vehicle distance, a relative speed, and basic acceleration torque as input factors, may be used to determine desired acceleration torque in consideration of an inter-vehicle distance and a relative speed.

FIG. 5A illustrates desired acceleration torque to an inter-vehicle distance, FIG. 5B illustrates desired acceleration torque to a relative speed, and a 3D map with desired acceleration torque set for inter-vehicle distances and relative speeds may be used in actual application. If a plurality of 3D maps constructed for basic acceleration torque is provided and one of them is selected for specific basic acceleration torque, it is possible to obtain desired acceleration torque for the corresponding inter-vehicle distance and relative speed from the selected map.

As shown in FIGS. 5A and 5B, as the inter-vehicle distance increases, the desired acceleration torque increases close to the basic acceleration torque (FIG. 5A), and as the relative speed increases (i.e., as the vehicle ahead increases in speed), the desired acceleration torque increases close to the basic acceleration torque (FIG. 5B), so values in a torque map are determined in consideration of these tendencies. When desired acceleration torque is obtained by correcting basic acceleration torque in this way, the control unit 20 determines the final slew rate by correcting the basic slew rate having the features of a driving system of a vehicle, in accordance with an inter-vehicle distance and a relative speed. A slew rate map, which is set such that a slew rate can be extracted on the basis of an inter-vehicle distance, a relative speed, and a basic slew rate as input factors, may be used to determine the final slew rate in consideration of an inter-vehicle distance and a relative speed.

FIG. 6A illustrates a slew rate to an inter-vehicle distance, FIG. 5B illustrates a slew rate to a relative speed, and a 3D map with slew rates set for inter-vehicle distances and relative speeds may be used in actual application. When a plurality of 3D maps constructed for basic slew rates is provided and one of them is selected for a specific basic slew, it is possible to obtain the final slew rate for the corresponding inter-vehicle distance and relative speed from the selected map.

As shown in FIGS. 6A and 6B, as the inter-vehicle distance increases, the final slew rate increases close to the basic slew rate (FIG. 6A), and as the relative speed increases (i.e., as the vehicle ahead increases in speed), the final slew rate increases close to the basic slew rate (FIG. 6B), so values in a slew rate map are set in consideration of these tendencies. Consequently, when desired acceleration torque and a slew rate are determined, the control unit 20 outputs a torque-related order on the basis of the desired acceleration torque and the slew rate (S15) and torque output from a power system is controlled in accordance with the torque-related order, such that acceleration torque for a vehicle is generated (S16).

Although desired acceleration torque and a slew rate are determined by correcting basic acceleration torque and a basic slew rate in accordance with an inter-vehicle distance and a relative speed in the above description, a road slope detected by the slope detector 14 may be additionally considered for the correction, other than the inter-vehicle distance and the relative speed. When a road slope is considered, it is corrected in the same way as the inter-vehicle distance and the relative speed, and accordingly, acceleration torque control additionally considering running resistance against a vehicle can be achieved. The larger the slope of an uphill road, the larger the running resistance, so the torque map and the slew rate map for correction are, respectively, set such that the larger the slope of an uphill road, the larger the desired acceleration torque and such that the larger the slope, the larger the final slew rate.

In view of the above, according to a system and a method of controlling acceleration torque of the present disclosure, it is possible to control acceleration torque based on information about a nearby vehicle, so fuel efficiency of a vehicle is improved. The acceleration torque control of the present disclosure described above may be carried out when a vehicle is driven normally without a selection by a driver, and it can be performed as well selectively by a driver operating a switch, such as when an ECO Mode is selected.

The disclosure has been described in detail with reference to embodiments thereof. However, it will be appreciated by those skilled in the art that changes may be made in these embodiments without departing from the principles and spirit of the disclosure, the scope of which is defined in the appended claims and their equivalents.

What is claimed is:

1. A system for controlling acceleration torque of a vehicle, comprising:
a driving information detection unit that detects driving information of the vehicle;
a forward-vehicle detector that detects information about another vehicle located substantially ahead of the vehicle; and
a control unit that calculates a basic acceleration torque and a basic slew rate of the vehicle when the vehicle is accelerating based on the detected driving information, calculates a desired acceleration torque and a final slew rate by correcting the basic acceleration torque and the basic slew rate based on the detected information about the other vehicle, and outputs a torque-related order to adjust a torque output from a power system of the vehicle to the desired acceleration torque in accordance with the final slew rate.

2. The system of claim 1, wherein the driving information detection unit includes:
a vehicle speed detector that detects a vehicle speed of the vehicle; and
an accelerator pedal position detection unit that detects an accelerator pedal position of the vehicle,
wherein the control unit calculates the basic acceleration torque based on the vehicle speed and the accelerator pedal position using a torque map.

3. The system of claim 1, further comprising:
a slope detector disposed in the vehicle that detects a road slope,
wherein the control unit corrects the basic acceleration torque and the basic slew rate based on the detected information about the other vehicle and the detected road slope.

4. The system of claim 1, wherein the information about the other vehicle includes one or more of an inter-vehicle distance between the vehicle and the other vehicle and a relative speed of the vehicle with respect to the other vehicle.

5. A method of controlling acceleration torque of a vehicle, comprising:
detecting driving information of the vehicle;
detecting information about another vehicle located substantially ahead of the vehicle;
calculating a basic acceleration torque and a basic slew rate based on the detected driving information;
calculating a desired acceleration torque and a final slew rate by correcting the basic acceleration torque and the basic slew rate based on the detected information about the other vehicle; and
outputting a torque-related order to adjust a torque output from a power system of the vehicle to the desired acceleration torque in accordance with the final slew rate.

6. The method of claim 5, wherein the detecting of the driving information of the vehicle comprises:
detecting a vehicle speed of the vehicle; and
detecting an accelerator pedal position of the vehicle,
wherein the basic acceleration torque is calculated based on the vehicle speed and the acceleration pedal position using a torque map.

7. The method of claim 5, further comprising:
detecting a road slope,
wherein the basic acceleration torque and the basic slew rate are corrected based on the detected information about the other vehicle and the detected road slope.

8. The method of claim 7, further comprising:
calculating the desired acceleration torque according to the detected road slope and a torque map; and
calculating the final slew rate according to the detected road slope and a slew rate map.

9. The method of claim 8, wherein:
the torque map is set such that a larger road slope corresponds to a larger desired acceleration torque, and
the slew rate map is set such that a larger road slope corresponds to a larger final slew rate.

10. The method of claim 5, further comprising:
calculating the desired acceleration torque according to a torque map.

11. The method of claim 5, further comprising:
calculating the final slew rate according to a slew rate map.

12. The method of claim 5, wherein the information about the other vehicle includes one or more of an inter-vehicle distance between the vehicle and the other vehicle and a relative speed of the vehicle with respect to the other vehicle.

13. The method of claim 12, further comprising:
calculating the desired acceleration torque according to a torque map,
wherein the torque map is set such that a larger road slope corresponds to a larger desired acceleration torque.

14. The method of claim 12, further comprising:
calculating the final slew rate according to a slew rate map,
the slew rate map is set such that a larger road slope corresponds to a larger final slew rate.

15. A non-transitory computer readable medium containing program instructions for controlling acceleration torque of a vehicle, the computer readable medium comprising:
program instructions that calculate a basic acceleration torque and a basic slew rate based on detected driving information of the vehicle;
program instructions that calculate a desired acceleration torque and a final slew rate by correcting the basic acceleration torque and the basic slew rate based on detected information about another vehicle located substantially ahead of the vehicle; and
program instructions that output a torque-related order to adjust a torque output from a power system of the vehicle to the desired acceleration torque in accordance with the final slew rate.
